(19) United States
(12) Patent Application Publication
(10) Pub. No.: US 2012/0004147 A1
(43) Pub. Date: Jan. 5, 2012

(54) COATED PARTICLES OF A CHELATING AGENT

(75) Inventors: Johannes Wilhelmus Franciscus Lucas Seetz, Twello (NL); Jéróme Mercanton, Gothenburg (SE); Paul Michael Ferm, Morristown, NJ (US); Martin Heus, Arnhem (NL); Zoltán Szilágyi, Karben (DE); Cornelis Elizabeth Johannus van Lare, Wijchen (NL)

(73) Assignee: AKZO NOBEL N.V., Arnhem (NL)

(21) Appl. No.: 13/142,464

(22) PCT Filed: Dec. 24, 2009
(86) PCT No.: PCT/EP2009/067913

§ 371 Date: Sep. 20, 2011

Related U.S. Application Data
(60) Provisional application No. 61/141,025, filed on Dec. 29, 2008.
(60) Provisional application No. 61/141,034, filed on Dec. 29, 2008.

(30) Foreign Application Priority Data
Jan. 29, 2009 (EP) 09151648.4
Jan. 29, 2009 (EP) 09151650.0

(51) Int. Cl. C09K 8/528; C02F 5/10; C09K 3/00; C11D 17/00

(52) U.S. Cl. 507/211; 510/224; 507/241; 252/175; 252/182.12

(57) ABSTRACT

The present invention relates to a coated particle including a particle including at least one chelating agent of the formula COOH—CHX—N—(CH₂—COOH)₂, wherein X stands for carboxyalkyl, alkyl, hydroxyalkyl or aminoalkyl, and alkyl is a C1-C4 alkyl group, and the coating on the particle includes at least one scale-inhibiting additive, a process to prepare such particle, and to the use thereof in detergents, in oil field applications, in agriculture and in water treatment.

The invention relates to particles of a chelating agent of the formula COOH—CHX—N—(CH₂—COOH)₂, to processes to produce said particles, and to the use of such particles.

The detergent market is currently undergoing important changes. Due to ecological and regulatory reasons the use of phosphate in high concentrations in detergent formulations is to be banned altogether or must at least be greatly reduced. The formulators of detergent products have to find alternatives to replace the phosphate compounds, with the most promising replacements being chelating agents such as GLDA, MGDA, IDS, HEIDA, and citrate. Such chelating agents are used in a concentration from 5% to 60%. Many detergent formulations contain co-builders, which are typically polymers or phosphonates. These co-builders are present in formulations in a concentration from 1% to 50%.

In powder or tablet detergent formulations, solid raw materials are required by the formulator. In, for example, automatic dishwashing (ADW) applications, the raw materials have to be in granule form to improve the tableting and solids handling of the formulation. These granules typically have a size comprised between 300 and 2,000 microns. The usual form in which glutamic acid N,N-diacetic acid (GLDA) and methylglycine N,N-diacetic acid (MGDA) are available is a liquid with an active content from 35% to 50%. After drying the substances, the powder or granules, especially when obtained in the amorphous state, show to a certain extent hygroscopic properties, which is unacceptable for the ADW formulators. Moreover, the granules obtained from the granulation process are brittle and thus cannot grow to the required size. In addition, whether in powder or granule form, the chelating agents GLDA and MGDA exhibit hygroscopic properties, rendering the material sticky and thus introducing storage, handling, and manufacturing problems. Flow properties of particles are critical in many ways. During manufacture of the particles themselves, they must flow smoothly relative to one another, e.g. in a fluid bed. Additionally, they must then be successfully transported to storage and transport containers. Finally, they must again be transported from storage and fed into a powder or tablet manufacturing facility. Flow problems arise due to several causes. For chelating agents, poor flow can be due to low glass transition temperatures, tackiness, wetness, and physical entanglement of multifaceted, irregularly shaped particles.

GLDA and MGDA are useful in ADW applications and other fields where a strong, green chelating agent is needed. The term “green” here denotes materials with a high renewable carbon content, a sustainable environmentally friendly production process, and/or a positive biodegradability assessment. The state of the art builders used in detergent formulations, such as sodium tripolyphosphate (STPP) and nitrilo triacetic acid (NTA), do not require a co-granulation or coating process. However, the hygroscopic, dusty, and sticky properties of amorphous MGDA and GLDA powder make co-granulation or coating highly desirable.

EP 1803801, WO 2006/002954, WO 2006/003434, and GB 2415695 describe particles of hygroscopic chelating agents coated with polymeric materials such as polyethylene glycol and polyvinylpyrrolidone. However, these materials used as a coating are quite often unwanted ingredients and therefore can be called a ballast in many applications of the chelating agents, for instance when they are used in detergents.

The object of the present invention is to provide particles of the chelating agents, the chelating agents being of the formula COOH—CHX—N—(CH₂—COOH)₂, wherein which the chelating agent is not only separated from the environment by a suitable coating, but wherein at least the majority of the coating is made of a material that is functional as a scale inhibitor, i.e. a material capable of inhibiting, solubilizing, crystal growth modification, dispersing, preventing, and/or removing scales in aqueous solutions. Another object of the present invention is to provide particles of chelating agents, the chelating agents being of the formula COOH—CHX—N—(CH₂—COOH)₂, wherein which the chelating agent is not only separated from the environment by a suitable coating, but wherein additionally the chelating agent is structured with a suitable structurant. A further object of the present invention is to use structurants which not only contribute to the mechanical integrity of the chelating agent, but which also function as sequestration materials or as builders.

Scale here refers to insoluble salts, such as CaCO3, that can form as crystals, films, or deposits on surfaces during the use of formulations containing the chelating agent. An additional object of the invention is to provide particles of the chelating agents of the formula COOH—CHX—N—(CH₂—COOH)₂, wherein the chelating agents are easier to handle and more storage stable, have a decreased speed of water uptake, are less hygroscopic, are easier to form into tablets, and have improved flow properties.

These objectives are achieved by the present invention, which provides coated particles in which the particles comprise at least one chelating agent of the formula COOH—CHX—N—(CH₂—COOH)₂, wherein X stands for carboxyalkyl, alkyl, hydroxyalkyl or aminoalkyl, and alkyl is a C1-C4 alkyl group and the coating applied on the particle contains at least one scale-inhibiting additive. The particles may optionally comprise structurants which improve the physical strength of the particle.

The invention additionally provides a process to prepare the above coated particles wherein a scale-inhibiting additive-containing material is applied on a chelating agent-containing material. Preferably the chelating agent-containing material is in a substantially dry form wherein substantially dry means that the chelating containing agent has a water content of below 10 wt %, preferably of below 6 wt %, on the basis of (total) solids.

It should be noted that plain mixtures of chelating agent and scale-inhibiting additive are known in the art. Such mixtures are disclosed for example in EP 884 381, which document discloses a mixture of GLDA, an anionic surfactant, a salt of a polymer comprising carboxylic acid units and a crystalline aluminosilicate at specific proportions. As demonstrated in the examples included in this specification, mixing the chelating agent and the scale-inhibiting additive will hardly have any beneficial effect in reducing the hygroscopic behaviour of the chelating agent.

The term “coated particles” as used throughout this application is meant to denote all particles (e.g. powder or granules) containing chelating agents of the above formula (e.g., a “core” or “particle”) which have been encapsulated, coated, matrix coated, or matrix encapsulated, with at least one other material (“the coating”), as a consequence of which the particles have other physical characteristics than the chelating agent without this coating. The particles can for instance have a modified color, shape, volume, apparent density, reactivity, durability, pressure sensitivity, heat sensitivity, and photosensitivity compared to the original chelating agent.

The coating surrounding the chelating agent will act to sufficiently delay the chelating agent from absorbing moisture thereby reducing the rate of particles sticking together or forming a solid mass. At the same time the coating layer has been found to be sufficiently water soluble in order to release the chelating agent sufficiently fast in the final application. Further, the particle once formulated will provide a stable particle size that will not change during storage or transportation. Further, the chelating agent in the (structured) particles can be protected from the effects of UV rays, moisture, and oxygen. Chemical reactions between incompatible species of particles can be prevented due to the coating and the particles exhibit greatly improved storage, handling, and manufacturing properties.

The advantage of using scale-inhibiting polymers and/or salts as a coating for the chelating agent is that these polymers can be or are already used as co-builders in most of the detergent formulations and will therefore have a beneficial effect during the wash. Therefore, the current invention gives a superior product form for the chelating agent and the encapsulating polymer also provides other benefits such as soil dispersancy, co-builder or crystal growth modification. Also, the particles of the present invention have excellent flow properties.

The particles may optionally also be mixed or co-dried with at least one other material (the “structurant”) providing structured particles. The (structured) particles have many useful functions and can be employed in many different areas, frequently connected with applications in which the chelating agent contents of the particle have to be released into the surrounding environment under controlled conditions.

Particles of chelating agents that are coated and, optionally, structured may take several different forms depending on the processing conditions and the choice of materials.

Referring to the Figures, they provide an illustration of several particles as further described below.

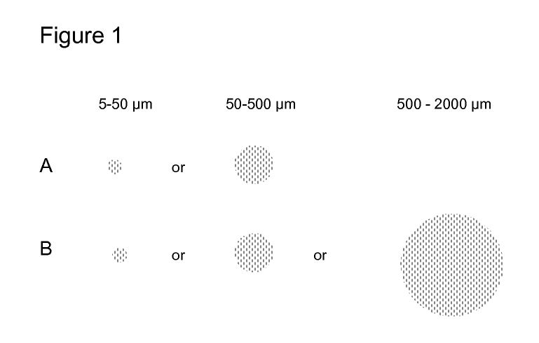

FIGS. 1A-B depict state of the art particles that are not coated.

FIG. 1A depicts schematically two different median particle sizes for a dried chelating agent. For example, 5-50 μm particles can be made (e.g. by spray drying) or 50-500 μm particles can be made (e.g. by fluid bed agglomeration).

FIG. 1B depicts schematically that when a structuring agent is used to provide more robust granules, the maximum size of the granules created (e.g. by fluid bed granulation) can be increased to 3,000 μm.

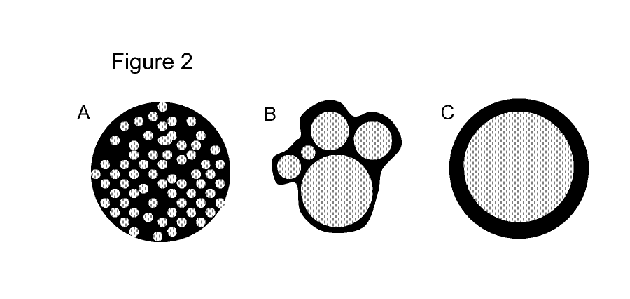

FIGS. 2A-C depict coated particles of this invention. FIG. 2A depicts the particles of this invention, where small 5-50 μm particles are coated in a continuous matrix of coating polymer, the matrix encapsulation coating is acquired by spray drying with a high amount of scale-inhibiting polymer.

FIG. 2B depicts a particle of this invention in which a set of larger chelating agent granules (or structured chelating agent granules) are coated with a thin layer of coating polymer.

FIG. 2C e.g. depicts the coating of a large structured granule in which an exterior polymer coating is created around an inner structured core.

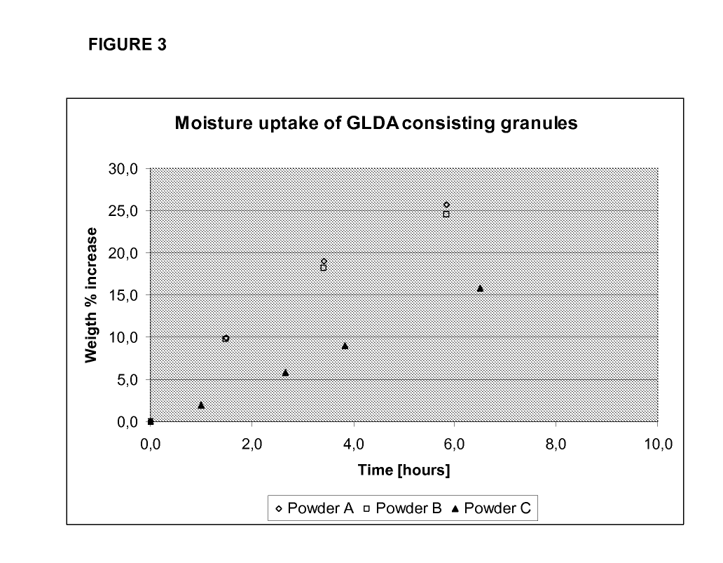

FIG. 3 is a graph depicting moisture uptake of GLDA consisting granules.

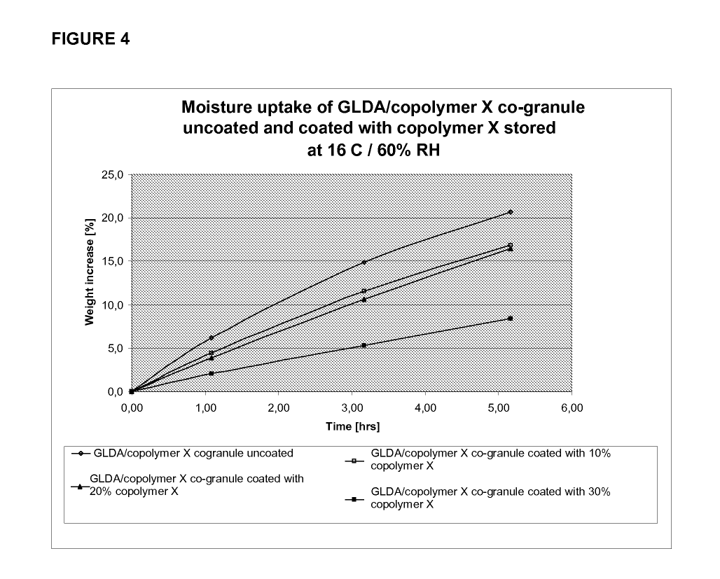

FIG. 4 is a graph depicting moisture uptake of GLDA/copolymer X co-granules uncoated and coated with copolymer X stored at 16° C. at 60% relative humidity.

It is known to those skilled in the art that the mechanical properties of the coating material can lead preferentially to the different coated particles shown in FIG. 2. Each particle can exhibit the improved qualities of the current invention and will exhibit a number of the different advantages. For instance, the particle depicted schematically by FIG. 2C will have the lowest surface area, due to the large particle size, and therefore the thickest layer of polymer coating for a particular polymer to chelating agent weight ratio. This particle, however, may require the use of a structuring agent to provide a robust inner structured particle. However, in cases where little structuring material is desired, a particle more similar to FIG. 2A may be created.

This invention covers the use of the coated particles in detergents, in oil field applications, in water treatment, in agriculture, and other applications that require or benefit from the multiple benefits provided by this invention, i.e. the dissolution of crystals, the sequestration of metal ions which can otherwise lead to crystal growth, and the inhibition of scale growth. One preferred embodiment of this invention is the use of the coated particles in automatic dish washing. Another preferred embodiment of this invention is the use of the particles in oil well completion and production operations.

The chelating agent is of the formula COOH—CHX—N—(CH₂—COOH)₂, wherein X stands for carboxyalkyl, alkyl, hydroxyalkyl or aminoalkyl, and alkyl is a C1-C4 alkyl group. Where in this application reference is made to chelating agents of the formula COOH—CHX—N—(CH₂—COOH)₂, also the (partial) salts thereof are included such as the alkali metal salts, the earth alkaline metal salts, and other salts known to a person of ordinary skill in the art. The chelating agent preferably is MGDA or GLDA (i.e. X is methyl or CH₂—CH₂—COOH). Even more preferably, it is GLDA. Most preferably, the chelating agent is HnYm-GLDA, wherein Y is a cation, e.g sodium, potassium or a mixture thereof, n+m=4, and m is between 0.8 and 3.9, preferably 1.5-3.8 most preferred 2.5-3.6. The chelating agent can be a partial salt of glutamic acid, N,N-diacetic acid of the above formula, if hydrogen cations are present in the coated particle, respectively, of from 0.1 to 3.2, preferably 0.2 to 2.5, or most preferably 0.4 to 1.5 per GLDA (tetra)anion.

As indicated above, most preferably, the particle comprises HnYm-GLDA wherein m is 0.8 to 3.9 and n is 0.1 to 3.2. However, also particles wherein the values of m and n are differently can be used. In such event, other components in the particle or in the coating are available to exchange protons with the GLDA (i.e. accept therefrom or provide thereto) making that effectively 0.1 to 3.2 hydrogen atoms are exchangeably available per GLDA anion.

It should be noted that the aforementioned most preferred salts of the chelating agent inherently correspond with performing the process to prepare the coated particles of the present invention at a certain pH range. In this respect, in a preferred embodiment the process to prepare the coated particles of the invention is conducted at a pH of 4-11, even more preferably 5-10. It was found that if the process is conducted at high (alkaline) pH, the chelating agent-containing material to be subjected to the coating process is in many cases so brittle that coating is undesirably difficult. Apparently the presence of free caustic in the liquid to be spray granulated, being in the range of 0.4-1.9 wt %, is too much for production of a good non-brittle granule. At the same time it was found that if the process is conducted at low (acidic) pH, due to a low softening point of the chelating agent a number of chelating agent-containing materials are sticky which makes that coating the chelating agent-containing material also undesirably difficult.

In an embodiment of the invention, the scale inhibiting additive is any polymeric additive that using the Scale Inhibition Test described hereinbelow gives a percent inhibition of 10% or more, preferably of 20% or more preferably using 1000 ppm of the scale inhibiting additive in the aqueous media and more preferably using 100 ppm of the scale inhibiting additive. In another embodiment, the scale inhibiting additive is derived from a scale-inhibiting salt.

The scale-inhibiting polymer found to be functional as a coating for the chelating agent can have a variety of chemical forms and specifically is selected from synthetic, natural, and graft or hybrid scale-inhibiting polymers. The synthetic polymer includes selected levels of carboxylation, sulfonation, phosphorylation, and hydrophobicity to give good film-forming and humidity resistance as well as good co-building and crystal growth inhibition properties. The natural polymers are likewise prepared with a combination of molecular weight modification, carboxylation, sulfonation, phosphorylation, and hydrophobic properties to give good co-building and crystal growth inhibition properties. The graft or hybrid polymers combine natural and synthetic monomers and polymers to give good co-building and crystal growth inhibition properties. Such hybrid copolymers are described, for example, in U.S. Patent Application Publication No. 2007/0021577 and U.S. patent application Ser. No. 12/533,802, filed Sep. 14, 2009, each of which applications are incorporated by reference in their entireties herein. Suitable graft copolymers may be those such as described in U.S. Patent Application Publication Nos. 2008/0021168, 2008/0020961(A1), 2008/0021167(A1) and 2008/0020948(A1), U.S. Pat. No. 5,760,154, U.S. Pat. No. 5,580,941, U.S. Pat. No. 5,227,446 each of which applications is incorporated by reference in its entirety herein.

The structurant can include several salts and/or inorganic additives which contribute to the strength of the resulting particles and may also function as sequestration agents or as builders. These inorganic additives found to be functional as a structurant for the chelating agents are citrate, carbonate, silicate, and sulfate salts. Preferably, the sodium salts of materials are used. Of these salts, sodium carbonate, sodium citrate, and sodium silicate are preferred due to their functionality. Alternatively inorganic (nano-) particles, such as silica can be used.

It should be understood that in an embodiment, the coated particles of the invention may contain two or more chelating agents.

The amount of chelating agent of the formula COOH—CHX—N—(CH₂—COOH)₂ present in the coated particle in an embodiment is at least 30 wt %, more preferably at least 50 wt %, even more preferably at least 60 wt %, and up to 95 wt % based on the total weight of the coated particle. In another preferred embodiment the particle comprises 1-40 wt % of scale-inhibiting additive and 60-99 wt % of chelating agent.

Additionally, it should be understood that the coated particles of the invention may contain two or more coatings, wherein at least one of them is a scale inhibiting additive

The amount of scale-inhibiting additive in the coating of the coated particle is at least 30 wt %, preferably at least 50 wt %, even more preferably at least 60 wt %, and up to 100 wt %.

The particles of the invention in an embodiment contain 15 to 95 wt % of the chelating agent, 0 to 40 wt % of the structurant, and 5 to 85 wt % of the scale-inhibiting additive. In a preferred embodiment they contain 20 to 80 wt % of the chelating agent, 0 to 20 wt % of the structurant, and 20 to 80 wt % of the scale-inhibiting additive, the total amounts of ingredients adding up to 100 wt %.

The particles of the invention in an embodiment have an average particle size of 100 to 3,000 micron (μm), preferably 200 to 2,000 micron, more preferably 500 to 1,000 micron.

Apart from the scale-inhibiting additive, the coating material may additionally contain other components, such as a polysaccharide or gum. Such polysaccharides found to be functional as a coating for the chelating agent can have a variety of chemical forms and specifically include starches and their ether and ester derivatives thereof, hydrophobically modified starches and celluloses and ether derivatives thereof, hydrophobically modified celluloses and ether derivatives thereof, dextrins and ether and ester derivatives thereof. In an embodiment of the invention the polysaccharide is may be beta limit dextrins and hydrophobically modified ester of these beta limit dextrins.

The advantage of using polysaccharides in accordance with this invention as a coating for the chelating agent may be that these polysaccharides can be or are already used as co-builder in most of the detergent formulations and will therefore have a beneficial effect during the wash. Therefore, the current invention may also provide a superior product form for the chelating agent and the encapsulating polymer that provides benefits such as co-builder or crystal growth inhibition. Also, the particles of the present invention have excellent flow properties. In addition, the use of polysaccharides or other materials containing renewable carbon atoms may allow at least the majority of the coating to be made of a renewable material that is a green alternative from an ecological point of view, and additionally may be generally cheaper than polyalkylene glycols, surfactants and polyvinylpyrrolidone compounds.

In an embodiment of the invention, the amount of polysaccharide or gum additive in the coating of the coated particle is at least 20 wt %, preferably at least 30 wt %, even more preferably at least 50 wt %, and preferably up to 80 wt %, preferably up to 70 wt % on basis of the total weight of the coating.

The synthetic polymers useful as scale inhibiting polymers in this invention are homopolymers or copolymers prepared from at least one hydrophilic acid monomer. These hydrophilic acid monomers contain carboxylic acid, sulfonic acid, phosphonic acid, and mixtures of these monomers and salts thereof. Examples of such hydrophilic acid monomers include but are not limited to acrylic acid, methacrylic acid, ethacrylic acid, α-chloro-acrylic acid, α-cyano acrylic acid, β-methyl-acrylic acid (crotonic acid), α-phenyl acrylic acid, β-acryloxy propionic acid, sorbic acid, α-chloro sorbic acid, angelic acid, cinnamic acid, p-chloro cinnamic acid, β-styryl acrylic acid (1-carboxy-4-phenyl butadiene-1,3), itaconic acid, maleic acid, citraconic acid, mesaconic acid, glutaconic acid, aconitic acid, fumaric acid, tricarboxy ethylene, 2-acryloxypropionic acid, 2-acrylamido-2-methyl propane sulfonic acid, vinyl sulfonic acid, sodium methallyl sulfonate, sulfonated styrene, allyloxybenzene sulfonic acid, and maleic acid. Moieties such as maleic anhydride or acrylamide that can be derivatized to an acid containing group can be used. Combinations of acid-containing hydrophilic monomers can also be used. Preferably, the polymer is prepared from hydrophilic acid monomers such as acrylic acid, maleic acid, methacrylic acid, 2-acrylamido-2-methyl propane sulfonic acid or mixtures thereof.

In addition to the hydrophilic monomers described above, hydrophobic monomers can also be used to prepare the copolymer. Hydrophobic monomers are defined as having a solubility in water of less than 10 grams per liter at 25° C. These hydrophobic monomers include, for example, ethylenically unsaturated monomers with saturated or unsaturated alkyl, hydroxyalkyl, alkylalkoxy groups, arylalkoxy, alkarylalkoxy, aryl and aryl-alkyl groups, alkyl sulfonate, aryl sulfonate, siloxane, and combinations thereof. Examples of hydrophobic monomers include styrene, α-methyl styrene, methyl methacrylate, methyl acrylate, 2-ethylhexyl acrylate, octyl acrylate, lauryl acrylate, stearyl acrylate, behenyl acrylate, 2-ethylhexyl methacrylate, octyl methacrylate, lauryl methacrylate, stearyl methacrylate, behenyl methacrylate, 2-ethylhexyl acrylamide, octyl acrylamide, lauryl acrylamide, stearyl acrylamide, behenyl acrylamide, propyl acrylate, butyl acrylate, pentyl acrylate, hexyl acrylate, 1-vinyl naphthalene, 2-vinyl naphthalene, 3-methyl styrene, 4-propyl styrene, t-butyl styrene, 4-cyclohexyl styrene, 4-dodecyl styrene, 2-ethyl-4-benzyl styrene, and 4-(phenyl butyl) styrene. Combinations of hydrophobic monomers can also be used. Scale inhibiting polymers incorporating hydrophobic monomers are preferred since they minimize the water absorption of the chelate particles.

The lower the pH of the scale inhibiting polymer, the less hygroscopic the polymer is as a dried product. The pH of the scale inhibiting polymer is preferably below 7, more preferably below 6 and most preferably below 4. The polymer is usually prepared as the acid and then neutralized to the required pH before mixing with the solution of the chelating agent. The neutralizing agent can be hydroxides such as NaOH or KOH or amines such as alkanol amines and other organic amines. One skilled in the art will recognize that hydrophobic amines would be preferred especially if the polymer is extremely water soluble. If the copolymer incorporates a large amount of hydrophobic monomer than it would be necessary to neutralized with NaOH or KOH to keep the polymer soluble.

The monomers detailed above are polymerized using a solution or suspension process. The process involves polymerization using free radical initiators with one or more of the above hydrophilic and/or hydrophobic monomers. These processes and the materials involved are known in the art.

In a preferred embodiment of the invention, the coating contains a copolymer of maleic acid/acrylic acid/methyl methacrylate/2-acrylamido-2-methyl propane sulfonic acid at 25-30/48-80/2-25/1-10 mole percent as the sodium salt.

In another preferred embodiment of the invention, the coating contains a homopolymer of acrylic acid monomer or a copolymer of acrylic acid and maleic acid.

The process to prepare the coated particles can be any process through which a coating layer containing scale-inhibiting additive is applied on the material containing the chelating agent.

Suitable processes are, for example, disclosed in the Kirk Othmer Encyclopedia of Chemical Technology, Vol. 16, Microencapsulation page 438-463 by C. Thies; John Wiley & Sons Inc. 2001 and include, but are not limited to, the following processes:

“Spray-dry encapsulation processes which involves spraying an intimate mixture of core and shell material into a heated chamber where rapid desolvation occurs”.

“Fluidized-bed encapsulation technology which involves spraying shell material in solution or hot melt form onto solid particles suspended in a stream of heated gas, usually air. Although several types of fluidized-bed units exist, so-called top and bottom spray units are used most often to produce microcapsules. In top-spray units, hot melt shell materials are sprayed onto the top of a fluidized-bed of solid particles. The coated particles are subsequently cooled producing particles with a solid shell. This technology is used to prepare a variety of encapsulated ingredients. In bottom-spray or Wurster units the coating material is sprayed as a solution into the bottom of a column of fluidized particles. The freshly coated particles are carried away from the nozzle by the airstream and up into the coating chamber where the coating solidifies due to evaporation of solvent. At the top of the column or spout, the particles settle. They ultimately fall back to the bottom of the chamber where they are guided once again by the airstream past the spray nozzle and up into the coating chamber. The cycle is repeated until a desired capsule shell thickness has been reached. Coating uniformity and final coated particle size are strongly influenced by the nozzle(s) used to apply the coating formulation. This technology is routinely used to encapsulate solids, especially pharmaceuticals (qv). It can coat a wide variety of particles, including irregularly shaped particles. The technology generally produces capsules >100-150 mm, but can produce coated particles <100 mm.”

In yet another example of a coating process, the coated particles are prepared by spraying the coating on the particle using a fluid bed coating process as, for example, described by E. Teunou, D. Poncelet; Batch and continuous fluid bed coating review and state of the art, J. Food Eng. 53 (2002), 325-340. In the conventional fluidized bed process, the fluidized bed is a tank with a porous bottom plate. The plenum below the porous plate supplies low pressure air uniformly across the plate leading to fluidization. The process comprises the following steps: (a) a compound to be encapsulated in the form of a powder is fluidized with air at an air inlet temperature below the melting temperature of the powder; (b) a coating liquid comprising a water based coating solution is sprayed onto the powder via a nozzle, followed by subsequent evaporation of the water by using elevated temperatures in the fluid bed. This leaves behind a coating layer on the particles with the compound in the core.

In a preferred embodiment of the invention the process to prepare the coated particles encompasses the preparation of a granule that is subsequently coated in a fluid bed coating process. The granule preparation is started by dissolving the chelating agent in water together with the coating material and if required a structurant. This mixture is sprayed into a hot spray drying chamber leading to the evaporation of water. The particles formed this way are recirculated in the spray chamber and at the same time spraying the water based mixture into the chamber is continued, due to which the particle grows and a granule is gradually formed. The composition gradient inside the granule can be modified by altering the composition of the spray mix while spraying it into the drying chamber. This means that the core of the particle can be higher in concentration of the compound whereas the outer part of the particle is enriched with the coating material. The particle formed is described as a co-granule as it consists of the compound, the coating material and if required a structurant. The obtained co-granule is subsequently coated in a fluid bed process. In this process, a powder is fluidized with warm air and a water based coating solution is sprayed onto the powder. The water is evaporated leaving behind a coating on the particle surface. The amount of coating can be controlled easily by manipulating the spray on time. This leaves behind a coating layer on the particles with the compound, for example, in the core.

### EXAMPLES

The test method to determine the scale-inhibiting functionality of a polymeric material is as follows:

To determine scale inhibition characteristics of polymeric materials, the percentage of calcium carbonate inhibition was measured as a function of treatment level according to the following procedure.

### Solution “A”:

A calcium-containing brine solution was prepared using calcium chloride dihydrate, 12.15 g/L, and sodium chloride, 33.00 g/L.

### Solution “B”:

A carbonate-containing brine solution was prepared using anhydrous sodium hydrogen carbonate, 7.36 g/L, and sodium chloride, 33.00 g/L.

### Antiscalant Preparation:

The total solids or activity for antiscalant(s) to be evaluated was determined. The weight of antiscalant necessary to provide a 1.000 g/L (1,000 mg/L) solids/active solution was determined using the following formula:

(% solids and/or activity)/100%=“X”

“X”=decimal solids or decimal activity
(1.000 g/L)/“X”=g/L antiscalant to yield a 1,000 mg/L antiscalant solution

### Indicator Solution:

A murexide indicator solution, 0.15 g murexide/100 ml ethylene glycol, was prepared.

### EDTA Solution

A 0.01 M EDTA solution, 3.722 g/L, was prepared,

### Sample Preparation:

Solution “A” and Solution “B” were saturated with carbon dioxide immediately before using. Saturation was accomplished at room temperature by bubbling CO₂ through a fritted-glass dispersion tube immersed to the bottom of the container for at least 30 minutes. Using an electronic pipet, the correct amount of antiscalant polymer solution was added to a 4 oz. French Square Bottle to give the desired treatment level (i.e., 1,000 ul of 1,000 mg/L antiscalant solution=10 mg/L in samples). Fifty (50) ml of Solution “B” was dispensed into the bottle using Brinkman dispensette. Fifty (50) ml of Solution “A” was dispensed into the bottle using a Brinkman dispensette. Using a Brinkman dispensette, at least three blanks (samples containing no antiscalant treatment) were prepared by dispensing 50 ml of Solution “B” and 50 ml of Solution “A” to a 4 oz. French Square Bottle.

The bottles were immediately capped and agitated to mix thoroughly. The sample bottles were immersed to ¾ of their height in a water bath set at 71° C.+/−5° C. for 16 to 24 hours.

### Sample Evaluation:

All of the bottles were removed from the water bath and allowed to cool to the touch. A vacuum apparatus was assembled using a 250 ml side-arm Erlenmeyer flask, vacuum pump, moisture trap, and Gelman filter holder. The samples were filtered using 0.2 micron filter paper. The filtrate was transferred from the 250 ml side-arm Erlenmeyer flask into an unused 100 ml specimen cup. Using an electronic pipet, the filtrate was immediately acidified by adding 500 μl of concentrated nitric acid. The samples were titrated using the following method:

### Samples and Blanks:

Into a 250 ml Erlenmeyer flask, 10 ml of filtrate was dispensed using a Class “A” volumetric pipet. Fifty (50) ml of deionized water was added to the flask. Into the flask, 2 ml of 1.0N NaOH were dispensed using an electronic pipet. Five (5) to 20 drops of the murexide indicator solution were added, to the flask. Using a Class “A” buret and 0.01 M EDTA solution, the sample was titrated to a purple-violet endpoint. Using a Class “A” volumetric pipet, 5 ml of solution “A” was dispensed into a 250 ml Erlenmeyer flask. Fifty (50) ml of deionized water was added to the flask. Into the flask, 2 ml of 1.0N NaOH was dispensed using an electronic pipet. Five (5) to 20 drops of the murexide indicator solution were added, to the flask. Using a Class “A” buret and 0.01 M EDTA solution, the sample was titrated to a purple-violet endpoint.

### Calculate The Percentage of Inhibition For All Samples:

The percentage of inhibition for each treatment level was determined by using the following calculation:

$$\frac{( S - B )}{( T - B )} \times 100 \% = \% Inhibition$$

S=ml EDTA solution for “sample”

T=ml EDTA solution for “total calcium”

B=ml EDTA solution for “blanks”

Several materials were subjected to the Scale Inhibition Test Method using 100 ppm of polymer.

Below are the results for the Scale Inhibition Test Method (at 100 ppm):

| Sample | Polymer | % Inhibition |
|---|---|---|
| 1 | copolymer of acrylic acid and 2-acrylamido- | 77.27 |
| | 2-methyl propane sulfonic acid (20 mole %) | |
| | sodium salt | |
| 2 | copolymer of acrylic acid and styrene (50 | 27.15 |
| | mole %) sodium salt | |
| 3 | copolymer of acrylic acid and maleic acid | 80.29 |
| | sodium salt | |
| 4 | copolymer of maleic acid/acrylic acid/methyl | 95.0 |
| | methacrylate/2-acrylamido-2-methyl | |
| | propane sulfonic acid at 25/64.5/4.5/6 mole | |
| | percent as the sodium salt | |
| 5 | hybrid polymer of maltodextrin (50 weight | 98.0 |
| | percent) with acrylic acid, monomethyl | |
| | maleate and hydroxypropyl methacrylate | |
| | (mole ratio 80/10/10) sodium salt | |
| 6 | graft copolymer of maltodextrin (65 weight | 96.0 |
| | percent) with acrylic acid and maleic acid | |
| | (33 mole %) sodium salt | |
| 7 | polyvinylpyrrolidone (PVP) | −0.3 |
| 8 | polyethylene glycol (PEG) | −0.4 |
| 9 | polyvinylalchol (PVOH) (such as Celvol ® | 0.03 |
| | 805 from Celanese Chemicals of Dallas, TX | |
| | USA | |

It is clearly illustrated that the coating materials of the state of the art do not have a scale-inhibiting functionality.

### Example 1

Three types of granules were made on basis of GLDA sodium salts; Dissolvine® GL-47-S (aq. sol of GLDA tetrasodium salt) and Dissolvine® GL-Na-40-S (aq. sol of GLDA monosodium salt) available from Akzo Nobel Functional Chemicals LLC, Chicago Ill. USA). The process to prepare the coated particles encompasses the preparation of a granule that is subsequently coated in a fluid bed coating process. The granule preparation is started with a chelating agent solution in water into which the coating material and if required also a structurant, can be mixed in when required. This mixture is sprayed into a hot spray drying chamber leading to the evaporation of water. The particles formed this way are recirculated in the spray chamber and at the same time spraying the water based mixture into the chamber is continued, due to which the particle grows and a granule is gradually formed.

When needed, the composition gradient inside the granule can be modified by altering the composition of the spray mix while spraying it into the drying chamber. This means that the core of the particle can be higher in concentration of the compound whereas the outer part of the particle is enriched with the coating material. The particle formed is described as a co-granule as it consists of the compound, the coating material and if required a structurant. The co-granule obtained is subsequently coated in a fluid bed process. In this process, a powder is fluidized with warm air and a water based coating solution is sprayed onto the powder. The water is evaporated leaving behind a coating on the particle surface. The amount of coating can be controlled easily by manipulating the spray on time.

Powder A (comparative) consisting of pure GLDA. Powder A is formed by mixing GL-47-S and GLNa-40-S in a 85:15 ratio. This mixture was continuously sprayed into a fluid bed spray granulator type AGT, equipped with cyclones, an external filter unit and a scrubber. During the spray granulation process, the air flow was kept between 700-1300 m3/hour and air inlet temperatures between 100 and 250° C. were used. This resulted in a free flowing powder.

Powder B (comparative) consisting of a mixture of 80% GLDA and 20% copolymer of maleic acid/acrylic acid/methyl methacrylate/2-acrylamido-2-methyl propane sulfonic acid at 25/64.5/4.5/6 mole percent as the sodium salt (“copolymer X”) made via spray granulation to form a co-granule (powder B, represented by FIG. 3). Powder B represents a plain mixture of GLDA and copolymer X, clearly not resulting in an effective coating layer in accordance with the invention. For powder B the same procedure was used as for powder A, except that the spray mix now consisted of GL-47-S and GL-Na-40-S in a 95:5 ratio mixed with an copolymer X polymer solution, where the ratio of total GLDA and copolymer X was 80:20.

Powder C is the pure GLDA granule coated with 20% copolymer X in a fluid bed with copolymer X. Powder C represents a particle structure as represented by FIG. 2C as a GLDA core is coated with copolymer X, i.e. a coated particle of chelating agent in accordance with the invention.

Powder C was produced by subsequently coating powder A with an copolymer X solution (about 45 wt % solution) in a GEA Aeromatic Strea-1 lab scale fluid bed coater, using a Wurster set-up and a two-fluid nozzle. Air inlet temperature used was 80° C. to evaporate the water from the copolymer X solution. The air flow was chosen such that visually an even fluidization was obtained, which meant a setting between 10 and 80% of the maximum air flow on the GEA Aeromatic Strea-1. The spray-on rate of the coating was chosen such that an even coating was obtained on the particles giving no particle aggregation (i.e. about 0.5 gram/minute), resulting in a particle structure represented by FIG. 2C. Spray coating was continued until 20 wt % (on dry basis) of copolymer X was coated onto the GLDA core.

Once the powders were produced, they were put into a climate chamber at 16° C., 60% Relative Humidity. The weight of the powder was measured at the start (t=0) and after certain time steps. The weight increase was recomputed into a % weight increase by using the following formula:

Weight % increase at time t=[Weight(at t=0)−Weight(at time t)]/[Weight (at t=0)].

The results of those measurements for the three powders are given below in the Table 1 and FIG. 3.

TABLE 1

| Time | Powder A | Powder B | Time | Powder C |
|---|---|---|---|---|
| [hours] | wt % water | wt % water | [hours] | Wt % water |
| 0.0 | 0.0 | 0.0 | 0.0 | 0.0 |
| 1.5 | 9.9 | 9.7 | 1.0 | 1.9 |
| | | | 2.7 | 5.8 |
| 3.4 | 19.0 | 18.2 | 3.8 | 9.0 |
| 5.8 | 25.7 | 24.5 | 6.5 | 15.7 |

The FIG. 3 shows especially the results for the first 10 hours of storage as this best exemplifies the rate of moisture pick-up for the three powders.

When comparing the results for powders A and B, the table and FIG. 3 show that the pure granule (powder A) and the mixture (powder B) have no significant different behaviour in moisture absorption. When a true core-shell structure, i.e. a coated particle, is used (powder C) one can clearly see from the table and figure that this gives a delayed moisture uptake.

### Example 2

GLDA chelating agent powder A from Example 1 was further agglomerated and simultaneously coated with copolymer X. The coating was achieved by fluid bed agglomeration of powder A with 20 wt % copolymer X. The polymer was sprayed as a solution with a flow that allowed proper coating. The inlet air temperature was 130° C., the product temperature 80-90° C., outlet air 70° C. This example contained larger particles as expected with around 50-75% of the particles having a diameter of less than 800 μm. The particle structure was comparable to that shown schematically in FIG. 2B. Compared to Example 1—powder A, the sample showed less fragile behavior and less clumping of the sample when tested by hand in the presence of ambient moisture. Powder that was squeezed together by hand for 30 seconds at room temperature in air having 50-65% relative humidity, was observed to be less clumsy when squeezing stopped and it was put on the table.

### Example 3

Two GLDA-products, being Dissolvine® GL-47-S and Dissolvine® GL-Na-40-S in a ratio of 95:5, were mixed with copolymer X, where the ratio of total amount of GLDA and copolymer X was 80:20, to form a spray mix. This spray mix was spray granulated to form a co-granule according to the same procedure as described in Example 2, where the structure can be described by FIG. 1. The GLDA/copolymer X co-granule was subsequently coated in a GEA Aeromatic lab scale fluid bed coater, using a Würster set-up and a two-fluid nozzle. Air inlet temperature used was 80° C. The air flow was chosen such that visually an even fluidization was obtained, which implies a setting between 10 and 80% of the maximum air flow on the GEA Aeromatic Strea-1. The spray-on rate was chosen such that an even coating was obtained on the particles giving no particle aggregation (i.e. about 0.5 gram/minute), resulting in a particle structure represented by FIG. 2C. The amount of copolymer X that was sprayed on was varied from 10 wt %, 20 wt % to 30% (on dry basis).

The resulting powders were all stored in a climate chamber operated at 16° C. and 60% Relative Humidity. The weight increase as a function of time was measured, as a measure for the rate of absorption of moisture. The weight increase was recomputed into a % weight increase by using the following formula:

Weight % increase at time t=[Weight(at t=0)−Weight(at time t)]/[Weight(at t=0)].

The results of those measurements for the powders is given below in the Table 2 and FIG. 4. The Table 2 and FIG. 4 clearly show that a coating layer of copolymer X gives a delayed effect on moisture absorption and the higher the level of copolymer X the slower the moisture uptake.

TABLE 2

| Storage | | GL47S/Na40S | GL47S/Na40S | GL47S/Na40S |
|---|---|---|---|---|
| time | GL47S/ | [95:5]/4160 | [95:5]/4160 | [95:5]/4160 |
| [hrs] | Na40S | (80:20) - | (80:20) - | (80:20) - |
| In | [95:5]/ | coated | coated | coated |
| 16 C./ | 4160 (80:20) | with 10% | with 20% | with 30% |
| 60% | uncoated | copolymer X | copolymer X | copolymer X |
| RH | wt % water | wt % water | wt % water | wt % water |
| 0.00 | 0.0 | 0.0 | 0.0 | 0.0 |
| 1.08 | 6.2 | 4.5 | 3.8 | 2.1 |
| 3.17 | 14.9 | 11.5 | 10.6 | 5.3 |
| 5.17 | 20.6 | 16.9 | 16.5 | 8.4 |

### Example 4

A solution of 47 wt % GLDA chelating agent (Dissolvine® GL-47-S), 47 wt % sodium carbonate, and 6% polymer copolymer X is created. This solution is fluid bed granulated on a GLATT lab unit at 120-130 C air inlet temperature, product temperature of approximately 80° C., outlet air temperature of 60-70° C. and an airflow of approximately 100 m3/hr to create the larger particle size distribution as shown schematically in FIG. 1B with a target particle size of 500 to 1000 μm. Then the particle as shown schematically in FIG. 2C is created using an outer coating of 20 wt % copolymer X polymer. The final particle consists of 25 wt % polymer (20 wt % as outer coating), 45 wt % GLDA chelate, and 30 wt % sodium carbonate. The sample has 90% particles having a diameter of less than 500 μm. Compared to powder A of Example 1, the sample shows less fragile behavior and less clumping of the sample when tested by hand in the presence of ambient moisture. For comparable testing see example 2.

### Example 5

A solution of 50 wt % GLDA chelating agent (Dissolvine® GL-38) and 50% Alcocap® 300 starch (available as a dissolved polymer solution or in dry form from AkzoNobel Surface Chemistry LLC, Chicago, Ill., USA) is created. This solution is fluid bed granulated to create the larger particle size distribution as shown schematically in FIG. 1B with a target particle size of 500 to 1000 μm.

### Example 6

A solution of 50 wt % GLDA chelating agent (Dissolvine® GL-38), 25 wt % sodium carbonate, and 25% polymer Alcocap® 300 starch is created. This solution is fluid bed granulated to create the middle particle as shown schematically in FIG. 1B with a target particle size of 50 to 500 μm. Then the particle as shown schematically in FIG. 2B is created using an outer coating of 15 wt % Alcocap® 300 starch. The final particle consists of 43 wt % polymer (21 wt % as outer coating), 43 wt % GLDA chelate, and 22 wt % sodium carbonate. The sample has 90% particles having a diameter of less than 500 μm. Compared to Example 1, the sample shows less fragile behavior and less clumping of the sample when tested by hand.

Although the invention is illustrated and described herein with reference to specific embodiments, the invention is not intended to be limited to the details shown. Rather, various modifications may be made in the details within the scope and range of equivalents of the claims and without departing from the spirit of the invention.

1. A coated particle including a particle comprising at least one chelating agent of the formula COOH—CHX—N—(CH₂—COOH)₂, wherein X is carboxyalkyl, alkyl, hydroxyalkyl or aminoalkyl, and alkyl is a C1-C4 alkyl group, and a coating on the particle comprising at least one scale-inhibiting additive, wherein the scale-inhibiting additive is a polymeric additive having a percent inhibition of 10% or more according to the Scale Inhibition Test using 1000 ppm of the scale-inhibiting additive in the aqueous media.

2. The coated particle of claim 1 wherein the particle contains at least 50 wt % of the chelating agent based on total weight of the coated particle.

3. The coated particle of claim 1 wherein the particle comprises 1-40 wt % of scale-inhibiting additive and 60-99 wt % of chelating agent.

4. The coated particle of claim 1 wherein the coating contains at least 50 wt % of scale-inhibiting additive.

5. The coated particle of claim 1, wherein the coating additionally contains a polysaccharide or gum additive.

6. The coated particle of claim 1, wherein the at least one chelating agent is glutamic acid, N,N-diacetic acid or a partial salt thereof, and wherein 0 to 3.2 hydrogen cations are present in the coated particle per GLDA anion.

7. The coated particle of claim 1, further comprising a structurant.

8. The coated particle of claim 7, wherein the structurant is selected from the group consisting of sodium carbonate, sodium citrate, sodium silicate, and sodium sulfate.

9. The coated particle of claim 1, wherein the median particle size for the particle is 50-1,000 μm.

10. A process for preparing the coated particle of claim 1 comprising applying a scale-inhibiting additive-containing material on a chelating agent-containing material.

11. The process of claim 10 further comprising mixing the chelating agent and the scale-inhibiting additive in a liquid environment, drying, participating and subsequently applying a scale-inhibiting additive-containing material on the particle.

12. The process of claim 10 further comprising maintaining the pH in the range of 4-11.

13. A detergent comprising the coated particle of claim 1.

14. An oilfield formulation comprising the coated particle of claim 1.

15. An agricultural formulation comprising the coated particle of claim 1.

16. A water treatment formulation comprising the coated particle of claim 1.
